(19) United States
(12) Patent Application Publication
(10) Pub. No.: US 2019/0213414 A1
(43) Pub. Date: Jul. 11, 2019

(54) Row Detection System

(71) Applicant: Intelinair, Inc., Champaign, IL (US)

(72) Inventors: Ara Victor Nefian, San Francisco, CA (US); Hrant Khachatryan, Yerevan (AM); Hovnatan Karapetyan, Yerevan (AM); Naira Hovakymian, Champaign, IL (US)

(73) Assignee: Intelinair, Inc, Champaign, IL (US)

(21) Appl. No.: 16/245,772

(22) Filed: Jan. 11, 2019

Related U.S. Application Data
(60) Provisional application No. 62/616,153, filed on Jan. 11, 2018.

(51) Int. Cl. G06K 9/00; G06T 7/11

(52) U.S. Cl. CPC G06K 9/00657; G06T 7/11; G06T 2207/30188; G06T 2207/20021; G06T 2207/10032

(57) ABSTRACT

A row detection system including an image gathering unit that gathers a high-altitude image having multiple channels, an image analysis unit that segments the high-altitude image into a plurality of equally size tiles and determines an index value based on at least one channel of the image, where the image analysis unit identifies rows of objects in each image.

### CROSS REFERENCE TO RELATED APPLICATIONS

This application is a non-provisional patent application that claims the benefit of and the priority from U.S. Provisional Patent Application No. 62/616,153, filed Jan. 11, 2018, titled ROW DETECTION SYSTEM.

### BACKGROUND OF THE INVENTION

The agriculture industry comprises a large portion of the world's economy. In addition, as the population of the world increases annually, more food must be produced by existing agricultural assets. In order to increase yields on existing plots of farm land, producers require a clear understanding of plant and soil conditions. However, as a single farm may encompass hundreds of acres, it is difficult to access the conditions of the farm land.

Currently, farmers rely on their observations of their land along with prior experience to determine the requirements to increase the yield of their farm land. These observations may include identifying locations of weeds, identifying plant illnesses and determining levels of crop damage. However, considering the large number of acres in the average farm, these observations are not a reliable method to increase yields. Therefore, a need exists for system that will allow a farmer to better understand the conditions of their farm land.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a row detection system including an image gathering unit that gathers a high-altitude image having multiple channels, an image analysis unit that segments the high-altitude image into a plurality of equally size tiles and determines an index value based on at least one channel of the image, where the image analysis unit identifies rows of objects in each image.

In another embodiment, the image analysis unit separates each tile into a first channel image and a second channel image.

In another embodiment, the image analysis unit calculates a frequency spectrum from the first channel image and the second channel image.

In another embodiment, the image analysis unit applies a mask to the first channel image and the second channel image.

In another embodiment, the image analysis unit calculates a maximum energy and average energy for the masked first channel image and the masked second channel image.

In another embodiment, the image analysis unit assigns a confidence score for the first channel image and the second channel image based on the calculated maximum energy and average energy of the first channel image and the second channel image.

In another embodiment, the image analysis unit determines the slope, offset and distance for each row in a tile having a low confidence level and each adjacent tile having a high confidence score.

In another embodiment, the image analysis unit selects tiles adjacent to the low confidence tile with the adjacent tiles having a high confidence level

In another embodiment, the image analysis unit calculates an average inter-row distance for each row identified in the low and high confidence tiles.

In another embodiment, the image analysis unit calculates a maximum row angle and a minimum row angles for each row in the low and high confidence tiles, and the image analysis unit creates a parallel line for each row from the high confidence tile into the low confidence tile using the inter-row distance and row angles.

Another embodiment includes a row detection system having a memory and a processor, with a method of identifying rows of objects in an image is performed in the memory, the method including the steps of gathering a high-altitude image having multiple channels via a an image gathering unit, segmenting the high-altitude image into a plurality of equally size tiles via the image gathering unit, and determining an index value based on at least one channel of the image via the image gathering unit, where the image analysis unit identifies rows of objects in each image.

Another embodiment includes the step of separating each tile into a first channel image and a second channel image.

Another embodiment includes the step of the step of calculating a frequency spectrum from the first channel image and the second channel image.

Another embodiment includes the step of the step of applying a mask to the first channel image and the second channel image.

Another embodiment includes the step of the step of calculating a maximum energy and average energy for the masked first channel image and the masked second channel image.

Another embodiment includes the step of the step of assigning a confidence score for the first channel image and the second channel image based on the calculated maximum energy and average energy of the first channel image and the second channel image.

Another embodiment includes the step of determining the slope, offset and distance for each row in a tile having a low confidence level and each adjacent tile having a high confidence score.

Another embodiment includes the step of selecting tiles adjacent to the low confidence tile with the adjacent tiles having a high confidence level

Another embodiment includes the step of calculating an average inter-row distance for each row identified in the low and high confidence tiles.

Another embodiment includes the step of calculating a maximum row angle and a minimum row angles for each row in the low and high confidence tiles, and the image analysis unit creates a parallel line for each row from the high confidence tile into the low confidence tile using the inter-row distance and row angles.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of a row identification system consistent with the present invention;

FIG. 2 depicts one embodiment of a row detection unit;

FIG. 3 depicts one embodiment of a communication device consistent with the present invention;

FIG. 5A depicts a schematic representation of a process used to calculate the normalized difference vegetation index (NDVI) for each image;

FIG. 5B depicts an example of a red field channel (a), NIR channel (b) and NDVI image (c);

FIG. 6 depicts a method of identifying rows in an image;

FIG. 7A depicts a schematic representation of a process used to determine the parameters of each tile;

FIG. 7B depicts a schematic representation of a method for computing tile row parameters;

FIG. 7C depicts a schematic representation of a process to refine the individual row areas.

FIGS. 8A, 8B and 8C demonstrates demonstrate that high energy and low frequency waves can exist, in case there are missing plants in the vegetation rows; and

FIG. 9 depicts a fully processed image.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

The row identification system 100 gathers medium to low resolution images gathered from an aircraft flying above 1,500 feet. Each image is then partitioned into equally sized tiles. Each tile is analyzed to identify objects within the tile. Adjacent tiles are then compared to identify similar objects in adjacent tiles. When the system 100 identifies an object that is inconsistent with adjacent objects, the system 100 identifies the area in the image containing the inconsistent object as an area requiring further statistical analysis. By comparing object areas to adjacent object areas to identify similar objects and dissimilar objects, the processing of large images covering multiple acres can be performed using less processing resources resulting in more images being processed and fewer images being gathered to analyze multiple acres of land.

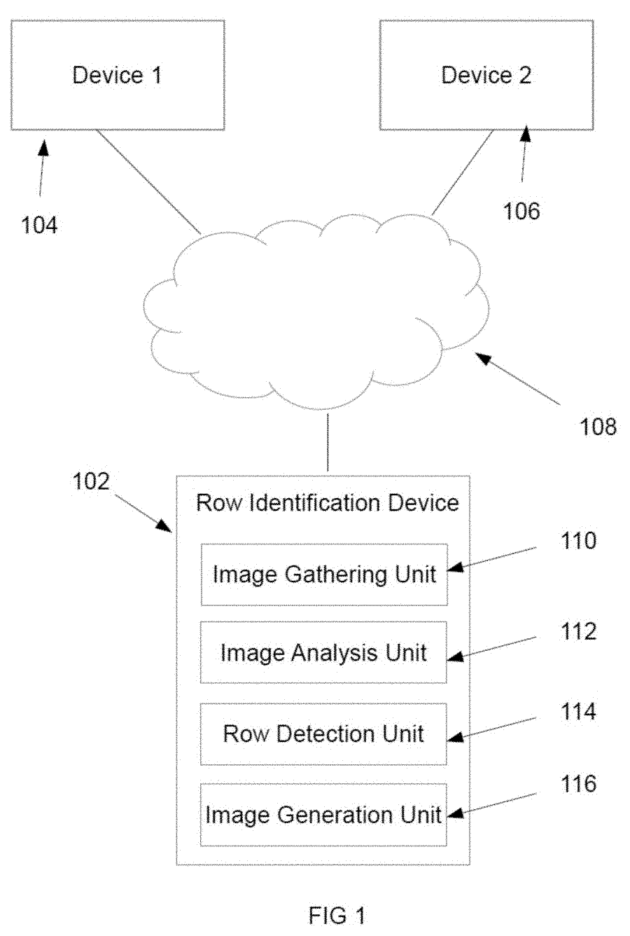

FIG. 1 depicts one embodiment of a row identification system 100 consistent with the present invention. The row identification system 100 includes a row identification device 102, a communication device 1 104, a communication device 2 106 each communicatively connected via a network 108. The row identification system 100 further includes an image gathering unit 110, an image analysis unit 112, a row detection unit 114 and an image generation unit 116.

The image gathering unit 110 and image analysis unit 112 may be embodied by one or more servers. Alternatively, each of the row detection unit 114 and image generation unit 116 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the row identification device may be servers, workstations, network appliances or any other suitable data storage devices. In another embodiment, the communication devices 104 and 106 may be any combination of cellular phones, telephones, personal data assistants, or any other suitable communication devices. In one embodiment, the network 102 may be any private or public communication network known to one skilled in the art such as a local area network (“LAN”), wide area network (“WAN”), peer-to-peer network, cellular network or any suitable network, using standard communication protocols. The network 108 may include hardwired as well as wireless branches. The image gathering unit 112 may be a digital camera.

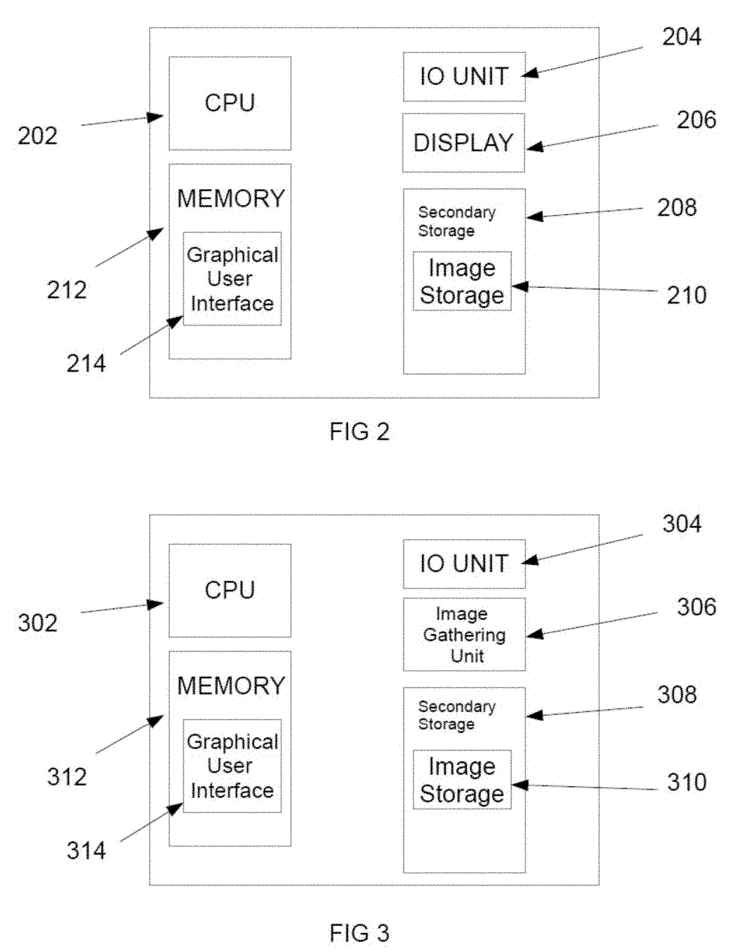

FIG. 2 depicts one embodiment of a row detection unit 102. The row identification device 102 includes a network I/O device 204, a processor 202, a display 206 and a secondary storage 208 running image storage unit 210 and a memory 212 running a graphical user interface 214. The image gathering unit 112, operating in memory 208 of the row detection unit 102, is operatively configured to receive an image from the network I/O device 204. In one embodiment, the processor 202 may be a central processing unit (“CPU”), an application specific integrated circuit (“ASIC”), a microprocessor or any other suitable processing device. The memory 212 may include a hard disk, random access memory, cache, removable media drive, mass storage or configuration suitable as storage for data, instructions, and information. In one embodiment, the memory 208 and processor 202 may be integrated. The memory may use any type of volatile or non-volatile storage techniques and mediums. The network I/O line 204 device may be a network interface card, a cellular interface card, a plain old telephone service (“POTS”) interface card, an ASCII interface card, or any other suitable network interface device. The row detection unit 114 may be a compiled program running on a server, a process running on a microprocessor or any other suitable port control software.

FIG. 3 depicts one embodiment of a communication device 104/106 consistent with the present invention. The communication device 104/1106 includes a processor 302, a network I/O Unit 304, an image capture unit 306, a secondary storage unit 308 including an image storage device 310, and memory 312 running a graphical user interface 314. In one embodiment, the processor 302 may be a central processing unit (“CPU”), a application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network or any suitable network, using standard communication protocols. The network 108 may include hardwired as well as wireless branches.

FIG. 4 depicts a schematic representation of a process used to identify rows in an image. In step 402, an image is captured by the image gathering unit 112. The image may be captured using any conventional methods of capturing a digital image. In one embodiment, the image is a high resolution raw image. In one embodiment, the image is captured from an aircraft flying at least 1,500 feet above the surface. In step 404, the image analysis unit 114 extracts each channel from the high resolution raw image. In one embodiment, the high resolution raw image includes a blue channel, a green channel, a red channel, a red-edge channel and a near-infrared channel. In step 406, the image analysis unit 114 normalizes the image across each channel. In step 408, a filter is applied to each normalized image. In step 410, each image is separated into equally sized tiles. In step 412, each tile is compared to determine whether a row exists in the image. To determine whether a row exists in an image, identified objects in each tile are compared with identified objects in adjacent rows. When an adjacent object is not similar, the system identifies the dissimilar area as an area different from the identified object. After a dissimilar area is identified, the system 100 compares the dissimilar object to other adjacent tiles to determine what the dissimilar object represents. Further, by identifying multiple adjacent dissimilar objects, the areas of vegetation and areas of non-vegetation can be identified with high accuracy.

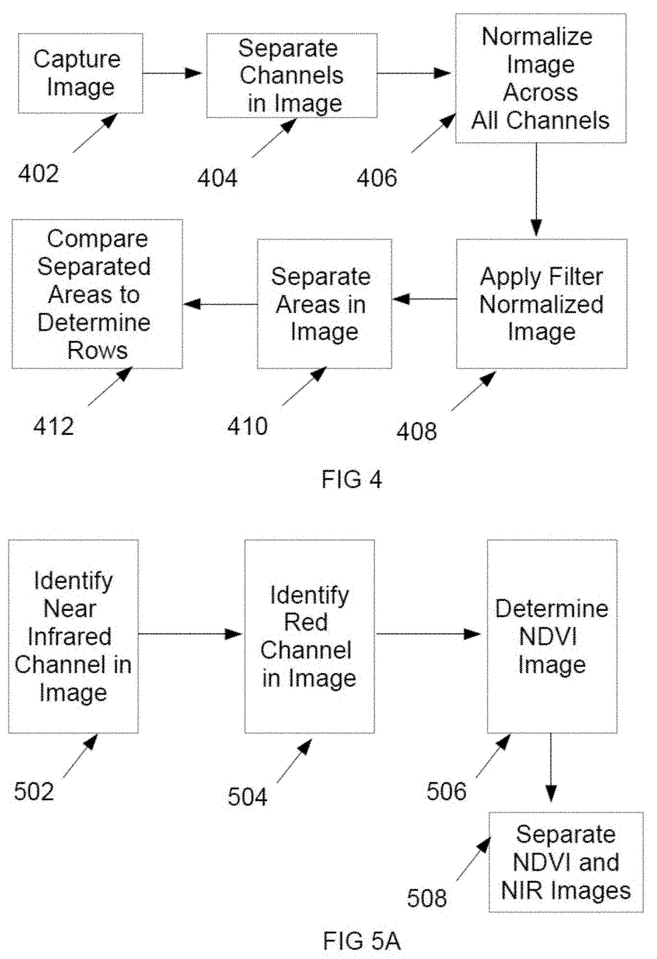

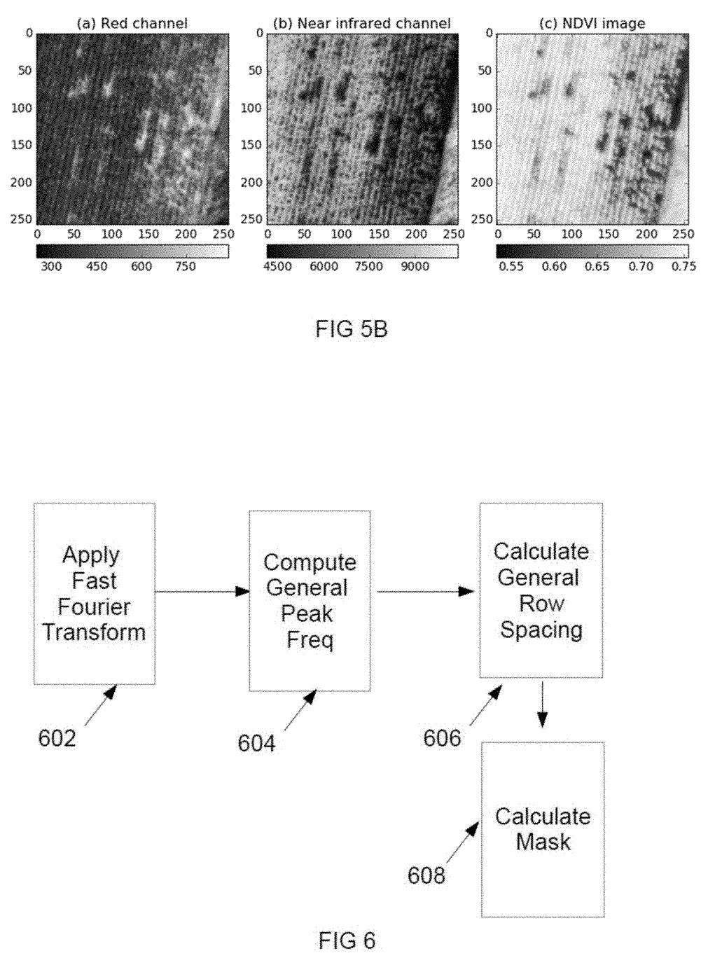

FIG. 5A depicts a schematic representation of a process used to calculate the normalized difference vegetation index (NDVI) for each image. In step 502, the near field channel is identified in the image by the image analysis unit 114 where the near field channel (NIR) is between 800 nm and 850 nm. In step 504, the red channel is identified in each image by the image analysis unit 114 where the red channel is between 650 nm and 680 nm. In step 506, the NDVI is calculated using the following equation:

$$NDVI = \frac{NIR - RED}{NIR + RED}$$

In step 508, the NDVI image and NIR images are separated non-overlapping tiles of equally sized pixels. In one embodiment, each tile is 256×256 pixels. FIG. 5B depicts an example of a red field channel (a), NIR channel (b) and NDVI image (c).

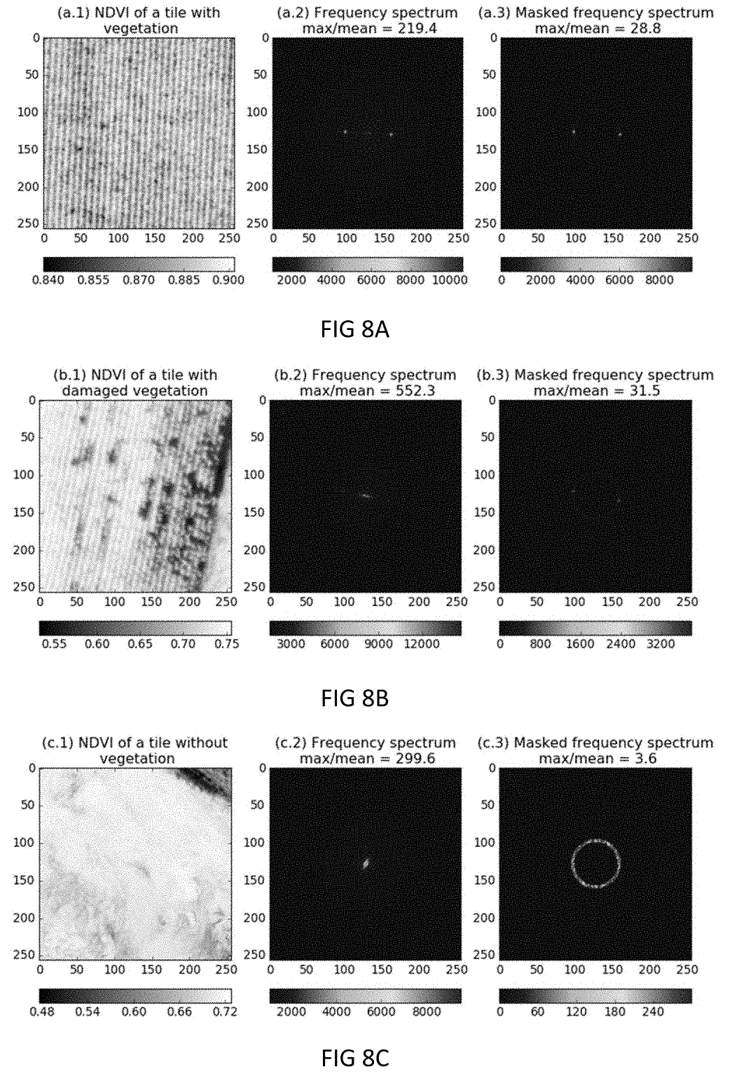

Planted vegetation seen in aerial images occurs in regular patterns often as parallel equidistant rows. FIG. 6 depicts a method of identifying rows in an image. In step 602, a Fast Fourier Transform (“FFT”) is applied to each NDVI image. The highest peaks in the FFT spectra (shown in light blue in FIGS. 8A-8C) are symmetrical to the FFT spectra image center and correspond to the lines that best describe the vegetation row. The two dimensional frequency location (x,y) of the peaks relate to the spacing between planted vegetation rows s according to Equation 1 below:

$$s = \frac{W}{\sqrt{{( \frac{W}{2} - x )}^{2} + {( \frac{W}{2} - y )}^{2}}}$$

Where w is the width of the tile.

In step 604 the general peak frequency is calculated as the median value of all the highest FFT peaks extracted in each of the NDVI tiles. In step 606, the general row spacing between the planted vegetation rows is computed using Equation 1 above for the general peak frequency.

In step 608, a binary mask of the same size is calculated with the NDVI tile (256×256 pixel in one implementation). The binary mask contains non-zero values only in the circle corresponding to the general peak frequency. In FFT domain this mask will select only peaks that correspond to vegetation rows separated by general row spacing described above.

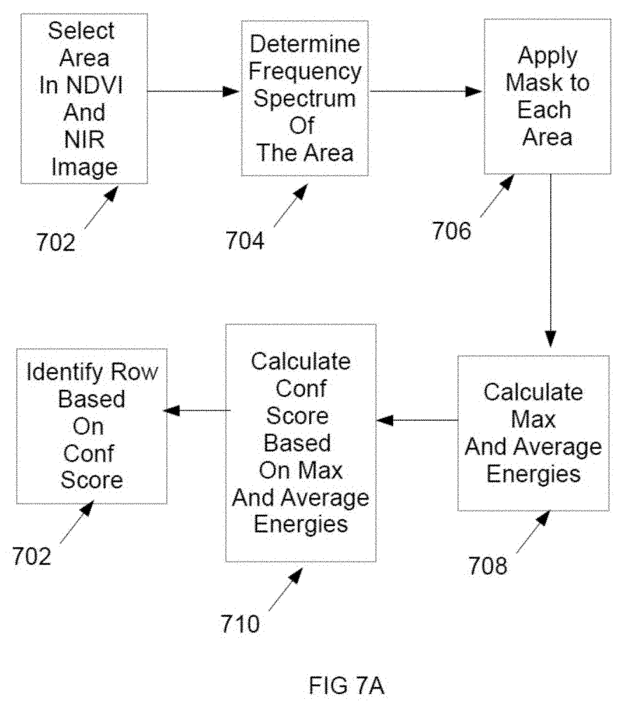

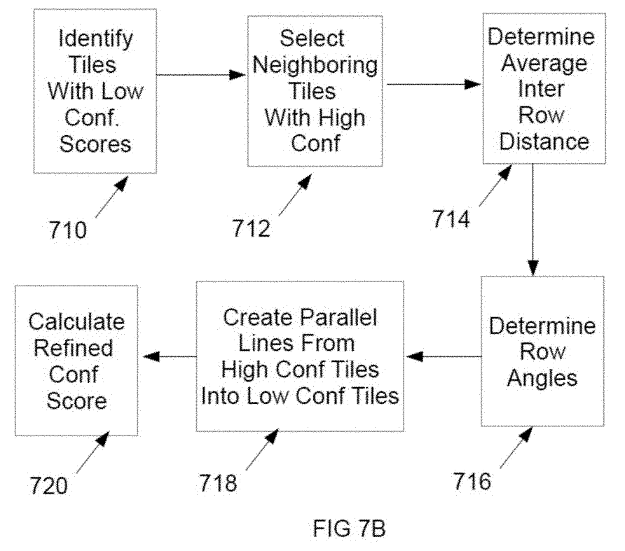

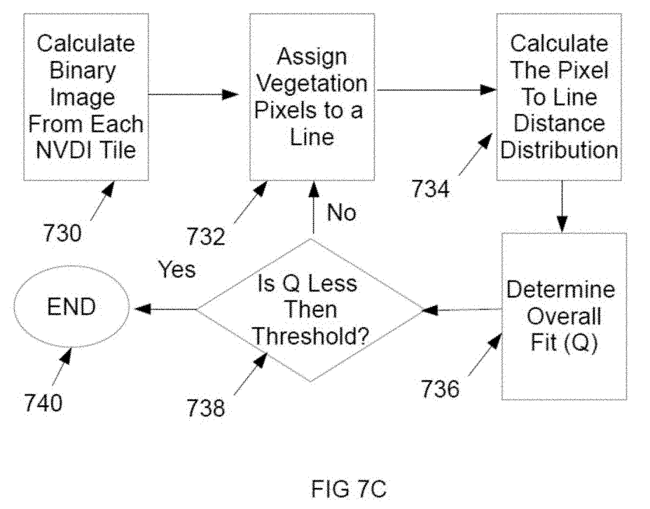

FIG. 7A depicts a schematic representation of a process used to determine the parameters of each tile. In step 702, each tile is selected from the NDVI and NIR images. In step 704, the frequency spectrum is calculated from each selected tile. In step 706, the mask is applied to each selected NDVI and NIR tile. In step 708, the maximum and average energies are calculated. In each masked frequency spectrum NDVI tile the maximum and average energies are calculated using the following equation:

c_{NDVI}=max(M∘F_{NDVI})/mean(M∘F_{NDVI}),

where ∘ denotes element-wise multiplication.

In each masked frequency spectrum NIR tile the maximum and average energies are calculated using the following equation:

c_{NIR}=max(M∘F_{NIR})/mean(M∘F_{NIR}).

In step 710, a confidence score is calculate using the following equation:

c=max(c_{NDVI},c_{NIR}/1.5)

In step 712, the rows are determined using the confidence score if the confidence score is above a predetermined threshold. The tiles without vegetation have higher of energy in low frequencies, while the tiles containing vegetation rows have high energy peaks in high frequencies.

FIG. 7B depicts a schematic representation of a method for computing tile row parameters. In step 710, the image analysis unit 112 determines the slope, offset and distance for each row in a tile having a low confidence level and each adjacent tile having a high confidence score. In one embodiment, a tile with a low confidence level is a tile where the computed value c is less than 20. In another embodiment, the high confidence tiles must be within a predetermined distance of the low confidence tile. In step 712, tiles adjacent to the low confidence tile having a high confidence level are selected. In step 714, the average inter-row distance (d_row) for each row identified in the low and high confidence tiles are calculated. In step 716, the maximum row angle (alpha_max) and minimum row angles (alpha_min) is calculate for each row in the low and high confidence tiles. In step 718, the image analysis unit creates parallel lines to each row from the high confidence tile in to the low confidence tile using the inter-row distance and row angles such that alpha_min<alpha<alpha_max. The bias of each parallel line is calculated using the following equation:

b_i=b_0+i*d_row

where i is the ith row in the tile. For each combination b_0 and alpha a new set of lines are created and a mask image is formed with 1 indicating points belonging to a line and 0 for points not belonging to a line. In step 720, a refined confidence score is calculated by determining the NVDI value for each of the new lines created. The lines with the highest confidence scores are identified as the rows in the low confidence tiles.

FIG. 7C depicts a schematic representation of a process to refine the individual row areas. In step 730, the binary image for each NDVI tile is calculated. High NDVI values correspond to vegetation while low NDVI values correspond to soil. In one embodiment, the binary segmentation includes Otsu segmentation method. In step 732, vegetation pixels are assigned to a line. In one embodiment, q_k denote the membership of a pixel p_k in a binary image tile to one of a line_i in the image tile, with d being the distance between p_k and line_i. In step 734, the pixel to line distance distribution is calculated using the following equation:

q_k=min_i_d(p_k,line_i)

Each pixel p_k is assigned to a line line_i for which the distance above is minimized. If the distribution is unimodal, fit the line parameters using the all samples. In one embodiment, the parameters of i_th line (b_i and alpha_i) are calculated using the set of pixels for which q_k=i. If the distribution is bimodal, the number of samples associated with each modality is determined. In step 736, the overall fit score is determined using the following equation:

Q=\sum_i\sum_k d(p_k,line_i)/number of all vegetation pixels

In step 738, If Q is less than a threshold value, the process ends. If Q is greater than a threshold value, the process returns to step 732.

FIGS. 8A, 8B and 8C demonstrate that high energy and low frequency waves can exist, in case there are missing plants in the vegetation rows. Applying a mask on the frequency spectrum allows differentiating between those cases and the tiles without any vegetation rows.

A binary mask of the row planted vegetation for the entire image may be created. The mask is generated only for tiles for which the confidence score is above a predetermined threshold. The binary mask may have a non-zero value for pixels corresponding to lines (parallel equidistant with the given slope and spacing).

NDVI intensities of the pixels on vegetation lines are grouped into three categories. First, mean m and standard deviation s of the NDVI intensities of the pixels on vegetation lines are calculated. The pixels having intensity less than m−3 s are grouped into category R. The pixels having intensity between m−3 s and m−1.5 s and are grouped into category Y. The remaining pixels on the vegetation lines are grouped into category. The coverage score c is calculated using the following formula:

$$C = 100 \cdot \frac{\vert G \vert + 0.5 * \vert Y \vert}{\vert G \vert + \vert Y \vert + \vert R \vert}$$

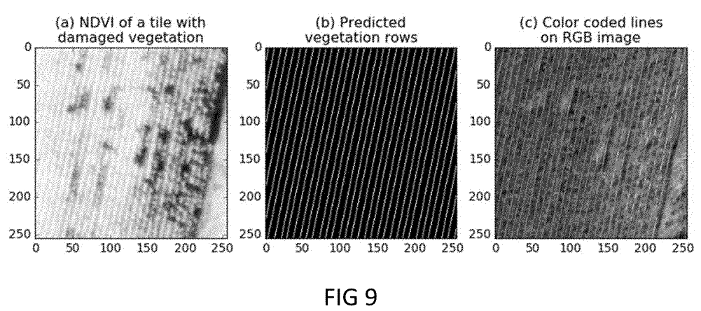

FIG. 9 depicts a fully processed image showing the identified rows. As the images depict, by segmenting the images by wavelength, separating the images into equally sized tiles and analyzing each tile, the areas of rows can be identified. As an illustrative example, image (b) in FIG. 9 clearly shows rows, indicated by the white lines, and areas between the rows indicated by the back areas. By performing a tile by tile analysis, the rows and spaces between the rows can be readily identified with a high level of accuracy.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A row detection system including:
an image gathering unit that gathers a high-altitude image having multiple channels;
an image analysis unit that segments the high-altitude image into a plurality of equally size tiles and determines an index value based on at least one channel of the image, wherein the image analysis unit identifies rows of objects in each image.

2. The row detection system of claim 1, wherein the image analysis unit separates each tile into a first channel image and a second channel image.

3. The row detection system of claim 2, wherein the image analysis unit calculates a frequency spectrum from the first channel image and the second channel image.

4. The row detection system of claim 3 wherein, the image analysis unit applies a mask to the first channel image and the second channel image.

5. The row detection system of claim 4, wherein the image analysis unit calculates a maximum energy and average energy for the masked first channel image and the masked second channel image.

6. The row detection system of claim 5, wherein the image analysis unit assigns a confidence score for the first channel image and the second channel image based on the calculated maximum energy and average energy of the first channel image and the second channel image.

7. The row detection system of claim 6, wherein the image analysis unit determines the slope, offset and distance for each row in a tile having a low confidence level and each adjacent tile having a high confidence score.

8. The row detection system of claim 6, wherein the image analysis unit selects tiles adjacent to the low confidence tile with the adjacent tiles having a high confidence level

9. The row detection system of claim 8, wherein the image analysis unit calculates an average inter-row distance for each row identified in the low and high confidence tiles.

10. The row detection system of claim 9, wherein the image analysis unit calculates a maximum row angle and a minimum row angles for each row in the low and high confidence tiles, and the image analysis unit creates a parallel line for each row from the high confidence tile into the low confidence tile using the inter-row distance and row angles.

11. A row detection system having a memory and a processor, with a method of identifying rows of objects in an image is performed in the memory, the method including the steps of:
gathering a high-altitude image having multiple channels via a an image gathering unit;
segmenting the high-altitude image into a plurality of equally size tiles via the image gathering unit, and
determining an index value based on at least one channel of the image via the image gathering unit,
wherein the image analysis unit identifies rows of objects in each image.

12. The method of claim 11, including the step of separating each tile into a first channel image and a second channel image.

13. The method of claim 12, including the step of calculating a frequency spectrum from the first channel image and the second channel image.

14. The method of claim 13, including the step of applying a mask to the first channel image and the second channel image.

15. The method of claim 14, including the step of calculating a maximum energy and average energy for the masked first channel image and the masked second channel image.

16. The method of claim 15, including the step of assigning a confidence score for the first channel image and the second channel image based on the calculated maximum energy and average energy of the first channel image and the second channel image.

17. The method of claim 16, including the step of determining the slope, offset and distance for each row in a tile having a low confidence level and each adjacent tile having a high confidence score.

18. The method of claim 16, including the step of selecting tiles adjacent to the low confidence tile with the adjacent tiles having a high confidence level

19. The method of claim 18, including the step of calculating an average inter-row distance for each row identified in the low and high confidence tiles.

20. The method of claim 19, including the step of calculating a maximum row angle and a minimum row angles for each row in the low and high confidence tiles, and the image analysis unit creates a parallel line for each row from the high confidence tile into the low confidence tile using the inter-row distance and row angles.
